(19) United States
(12) Patent Application Publication
(10) Pub. No.: US 2015/0144243 A1
(43) Pub. Date: May 28, 2015

(54) PNEUMATIC TIRE

(71) Applicant: BRIDGESTONE CORPORATION, Tokyo (JP)

(72) Inventor: Yasuyo SAITO, Hino-shi (JP)

(73) Assignee: BRIDGESTONE CORPORATION, Tokyo (JP)

(21) Appl. No.: 14/549,009

(22) Filed: Nov. 20, 2014

(30) Foreign Application Priority Data
Nov. 28, 2013 (JP) 2013-245964

(51) Int. Cl. B60C 15/06; B60C 1/00

(52) U.S. Cl. CPC B60C 15/06; B60C 1/00
USPC 152/541

(57) ABSTRACT

A pneumatic tire, which may include a bead portion reinforcing cord layer disposed along a turn-up portion of a carcass, includes at least one component member selected from the group consisting of a carcass cord ply and a belt cord layer and/or the bead portion reinforcing cord layer including an end rubber wrapping the end part thereof, the end rubber having a loss tangent larger than 0.20 and 0.35 or smaller at 2% strain at 25° C. and a difference ΔE′ between a storage modulus at 0.1% strain and a storage modulus at 2% strain at 25° C. being 10 MPa or more and 30 MPa or less, and a coating rubber covering a cord in the component member and/or the bead portion reinforcing cord layer including the end rubber has a loss tangent at 2% strain at 25° C. of 0.20 or less.

### CROSS-REFERENCE TO RELATED APPLICATION

This application is based on and claims priority under 35 USC 119 from Japanese Patent Application No. 2013-245964, filed Nov. 28, 2013, the disclosure of which is incorporated by reference herein.

### TECHNICAL FIELD

The present invention relates to a pneumatic tire.

### BACKGROUND ART

Conventionally, there has been high demands for improved fuel efficiency of a vehicle such as an automobile and the like, and it has been known that the improvement in fuel efficiency is greatly affected by the physical properties of rubber for use in tires provided to the vehicle, in particular, the low heat generation property of the rubber. In light thereof, it has been hitherto proposed a technology of improving the low heat generation property by adjusting the amount of a filler such as a carbon black and the like included in the rubber and the size of particles constituting the filler. For example, it has been reported in Patent Literature 1 (PTL 1) that a tire using a carbon black having a specific nitrogen adsorption specific surface area (N₂SA) and DBP oil absorption is capable of effectively achieving the low heat generation property during running of the tire.

Such reduction in amount of the filler and increase in size of the particles constituting the filler may indeed lower heat generation in the rubber. However, such technique in turn deteriorates the crack growth resistance of the rubber in itself. As a result, a component member of a tire, such as a carcass ply, suffers from a crack generated from, particularly, the end part thereof where strain and stress are concentrated, leading to a problem that the tire's internal structure is damaged, that is, the durability of the tire is deteriorated. As a method of reinforcing the end part of a component member so as to enhance the durability of the tire, there has been conventionally proposed a means of wrapping the end part of a component member with a rubber (which is so-called an end rubber) as illustrated in, for example, Patent Literature 2 (PTL 2).

### CITATION LIST

### Patent Literature

PTL 1: JP 2005-290024 A

PTL 2: JP H9-156325 A

### SUMMARY OF INVENTION

### Technical Problem

However, the aforementioned conventional technique has not been sufficient enough to achieve both the low heat generation property and the durability at a high level in a pneumatic tire. Accordingly, there has been a need for improvement in conventional tires described above, in terms of simultaneously improving the low heat generation property and the durability.

Under the aforementioned circumstances, the present invention has an object of providing a pneumatic tire in which low heat generation property and durability are both satisfied at a high level.

### Solution to Problem

The inventors of the present invention have made extensive studies to achieve the aforementioned object, and obtained a novel finding as follows. That is, component members (a carcass cord ply, a belt cord layer, and a bead portion reinforcing cord layer) constituting a pneumatic tire each may be provided with, at the end part thereof, an end rubber for wrapping the end part, and further, a coating rubber used in at least one of the component members may have a loss tangent (tanδ) at 2% strain at 25° C. defined in a specific range, in addition to which the end rubber wrapping the end part of the component member may have a loss tangent (tanδ) at 2% strain at 25° C. defined in a specific range and a difference (ΔE′) between a storage modulus (MPa) at 0.1% strain and a storage modulus (MPa) at 2% strain at 25° C. of the end rubber is also defined in a specific range, with the result that the tire can have both a low heat generation property and durability satisfied at high level, to thereby complete the present invention.

That is, an object of the present invention is to advantageously solve the aforementioned problem, and a pneumatic tire of the present invention includes a carcass formed of a carcass cord ply which toroidally extends across a pair of bead portions each having a bead core embedded therein, a pair of sidewall portions, and a tread portion; and a belt formed of a belt cord layer disposed on the tire-radial-direction outside of a crown portion of the carcass, in which:

at least one of the component members, which are the carcass cord ply and the belt cord layer, includes an end rubber wrapping the end part of at least one of the component members;

the end rubber has a loss tangent (tanδ) at 2% strain at 25° C. of larger than 0.20 and 0.35 or smaller, and a difference ΔE′ between the storage modulus (MPa) at 0.1% strain and the storage modulus at 2% strain at 25° C. of 10 MPa or more and 30 MPa or less; and

a coating rubber covering a cord in the at least one of the component members including the end rubber has a loss tangent (tanδ) at 2% strain at 25° C. of 0.20 or less. With this configuration adopted, there can be obtained a pneumatic tire capable of satisfying both the low heat generation property and the durability at a high level.

Then, in the pneumatic tire of the present invention, at least one of the component members including the end rubber may preferably a belt cord layer, for the following reason. That is, the pneumatic tire can sufficiently be improved in durability when the belt layer is adapted as one of the component members including the end rubber.

Further, the present invention has an object of advantageously solving the aforementioned problem, and a pneumatic tire of the present invention includes: a carcass formed of a carcass cord ply which toroidally extends across a pair of bead portions each having a bead core embedded therein, a pair of sidewall portions, and a tread portion; a belt formed of a belt cord layer disposed on the tire-radial-direction outside of a crown portion of the carcass; and a bead portion reinforcing cord layer disposed along a turn-up portion of the carcass, in which:

the bead portion reinforcing cord layer includes an end rubber wrapping the end part thereof;

the end rubber has a loss tangent (tanδ) at 2% strain at 25° C. of larger than 0.20 and 0.35 or smaller and a difference ΔE′ between the storage modulus (MPa) at 0.1% strain and the storage modulus at 2% strain at 25° C. of 10 MPa or more and 30 MPa or less; and

a coating rubber covering a cord in the bead portion reinforcing cord layer has a loss tangent (tanδ) at 2% strain at 25° C. of 0.20 or less. With this configuration adopted, there can be obtained a pneumatic tire capable of satisfying the low heat generation property and the durability at high level.

Here, in the pneumatic tire of the present invention, the coating rubber may preferably contain: a diene rubber; and a carbon black having a nitrogen adsorption specific surface area (N₂SA) of 90 m²/g or less in an amount of 20 to 60 parts by mass per 100 parts by mass of the diene rubber, for the following reason. That is, with the coating rubber containing: a diene rubber; and the aforementioned specific amount of a carbon black having the aforementioned specific nitrogen adsorption specific surface area (N₂SA), the pneumatic tire can be sufficiently improved in low heat generation property.

Then, in the pneumatic tire of the present invention, the end rubber may preferably contain: a diene rubber; and a carbon black having a nitrogen adsorption specific surface area (N₂SA) of 70 m²/g or more in an amount of 50 to 90 parts by mass per 100 parts by mass of the diene rubber, for the following reason. That is, with the end rubber containing: a diene rubber; and the aforementioned specific amount of a carbon black having the aforementioned specific nitrogen adsorption specific surface area (N₂SA), the pneumatic tire can be sufficiently improved in durability.

Further, in the pneumatic tire of the present invention, the end rubber may preferably be obtained by using a rubber master batch produced by mixing a natural rubber latex with a slurry solution of a carbon black previously dispersed in a liquid, for the following reason. That is, with the end rubber being obtained by using the rubber master batch as described above, the carbon black is more uniformly dispersed in the end rubber, to thereby sufficiently improve the pneumatic tire in durability.

Moreover, in the pneumatic tire of the present invention, the end rubber may preferably contain a hydrazide compound, for the following reason. That is, with the end rubber containing a hydrazide compound, the carbon black is more uniformly dispersed in the end rubber, to thereby sufficiently improve the pneumatic tire in durability.

In addition, in the pneumatic tire of the present invention, the end rubber and the coating rubber each may preferably contain at least one of a natural rubber and a polyisoprene rubber, for the following reason. That is, with the end rubber and the coating rubber each containing at least one of a natural rubber and a polyisoprene rubber, the pneumatic tire can be sufficiently improved in durability.

Then, in the pneumatic tire of the present invention, the end rubber and the coating rubber each may preferably contain a natural rubber, and the content of the natural rubber in the rubber component may preferably be 50 mass % or more, for the following reason. That is, with the end rubber and the coating rubber each containing a natural rubber of 50 mass % or more in the rubber component, the pneumatic tire can be sufficiently improved in durability.

### Advantageous Effect of Invention

The present invention is capable of providing a pneumatic tire in which low heat generation property and durability are both satisfied at a high level.

### BRIEF DESCRIPTION OF DRAWINGS

The present invention will be further described below with reference to the accompanying drawings, wherein:

FIG. 1 is a cross-sectional view in the tire width direction of a representative pneumatic tire according to the present invention;

FIG. 2 is a cross-sectional view in the tire width direction of a bead portion of another pneumatic tire according to the present invention; and

FIG. 3 is a cross-sectional view in the tire width direction of the bead portion of further another pneumatic tire according to the present invention.

### DESCRIPTION OF EMBODIMENTS

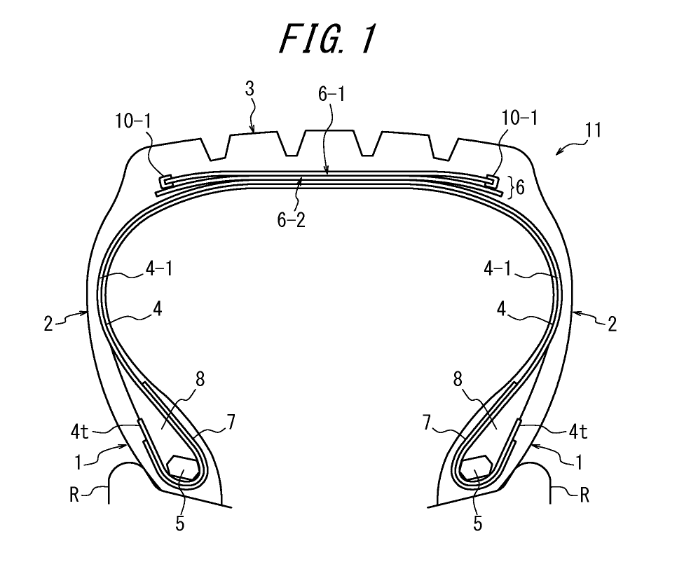

In the following, embodiments of the present invention will be described in detail with reference to the accompanying drawings. FIG. 1 schematically illustrates a cross-sectional structure in the tire width direction of a pneumatic tire according to the present invention.

As illustrated in FIG. 1, the pneumatic tire 11 according to the present invention includes: a carcass 4 formed of at least one layer of carcass cord ply (one layer of carcass cord ply 4-1 in FIG. 1) which toroidally extends across a pair of bead portions 1 each having a bead core 5 embedded therein, a pair of sidewall portions 2, and a tread portion 3; and a belt 6 formed of a plurality of belt cord layers (two layers of belt cord layers 6-1, 6-2 in FIG. 1) disposed on the tire-radial-direction outside of a crown portion of the carcass 4.

The carcass 4 has a turn-up portion 4t turned up around the bead core 5 from the inside to the outside of the tire. Then, disposed along the turn-up portion 4t, or along the outside of the turn-up portion 4t in FIG. 1, is a bead portion reinforcing cord layer 7 of the bead portion 1. The bead portion reinforcing cord layer 7, which is configured to be turned up along the turn-up portion 4t to reach the carcass 4 main body side in FIG. 1, should be disposed at least on the turn-up portion 4t side. Here, in the pneumatic tire of the present invention, the bead portion reinforcing cord layer 7 is not indispensable in the case where the bead portion reinforcing cord layer has an end rubber at the end part thereof.

The carcass 4 is formed of one or more layers of radially-arranged carcass cord plies (one layer in FIG. 1). The belt 6 is formed of a multilayer laminate of a plurality (two in FIG. 1) of belt cord layers, in which at least two layers adjacent to each other serve as a cord-cross layer. Then, the carcass cord ply 4-1 forming the carcass 4, the belt cord layers 6-1, 6-2 forming the belt 6, and the bead portion reinforcing cord layer 7 are each formed of a cord embedded in a coating rubber, as in a conventional manner. Here, the type of the cord to be used is not particularly limited, and preferred examples thereof may include a steel cord, an organic fiber cord, with a steel cord being preferred. The use of steel cord may improve the durability of the pneumatic tire.

Then, at least one component member selected from the group consisting of the carcass cord ply forming the carcass 4, the belt cord layers forming the belt 6, and the bead portion reinforcing cord layer 7 has its end part wrapped with an end rubber. The shape of such end rubber is not particularly limited as long as being capable of wrapping the end part, but preferably be in a sheet-like shape so as to efficiently wrap the end part while saving the amount of material for use as the end rubber. In the example illustrated in FIG. 1, both end parts of the belt cord layer 6-1 of the belt 6 are wrapped with a sheet-like end rubber 10-1. The sheet-like end rubber may be of separate sheet-like end rubbers for wrapping the end part sandwiched therebetween.

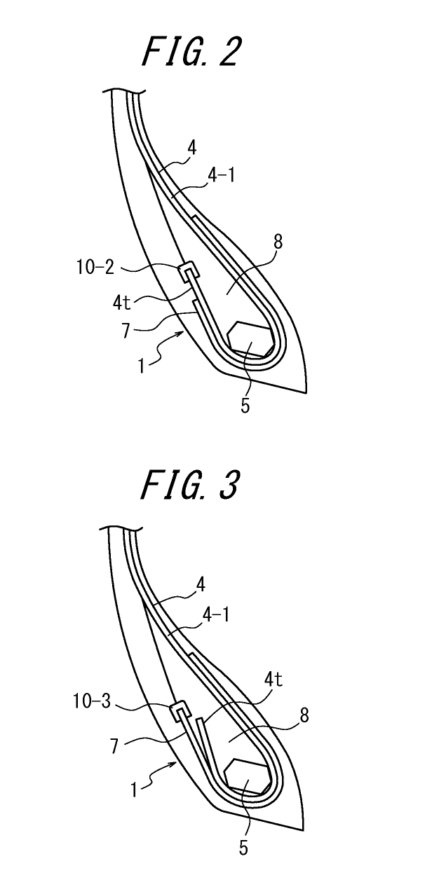

Then, in the example illustrated in FIG. 2 which renders one side of the bead portion 1, the turn-up portion 4t of the carcass cord ply 4-1 in the carcass 4 has an end part thereof wrapped with an end rubber 10-2.

Further, in the example illustrated in FIG. 3 which renders one side of the bead portion 1, the bead portion reinforcing cord layer 7 along the turn-up portion 4t of the carcass 4 has an end part thereof on the tire-radial-direction outside wrapped with an end rubber 10-3.

Further, in the pneumatic tire of the present invention, the end rubber has a loss tangent (tanδ) at 2% strain at 25° C. of larger than 0.20 and equal to or smaller than 0.35 and a difference ΔE′ between the storage modulus (MPa) at 0.1% strain and the storage modulus (MPa) at 2% strain at 25° C. of 10 MPa or more and 30 MPa or less, and a coating rubber covering a cord in a component member including the end rubber has a loss tangent (tanδ) at 2% strain at 25° C. of 0.20 or less.

As a result of simultaneously using such end rubber and coating rubber having the specific physical properties as described above, the pneumatic tire of the present invention can be imparted with excellent low heat generation property and durability.

(End Rubber)

### <Loss Tangent at 25° C.>

In the pneumatic tire of the present invention, at least one component member selected from the group consisting of the carcass cord ply, the belt cord layer, and the bead portion reinforcing cord layer, has the end part thereof wrapped with an end rubber with has a loss tangent (tanδ) at 2% strain at 25° C. (hereinafter, referred to as ‘tan6 (25° C.)’ as appropriate) that is larger than 0.20, preferably 0.30 or larger, and 0.35 or smaller. The end rubber having tanδ (25° C.) of 0.20 or less fails to ensure the crack growth resistance particularly at the end part covered by the end rubber, with the result that the durability of the tire cannot be ensured. On the other hand, the end rubber having tanδ (25° C.) larger than 0.35 fails to ensure excellent low heat generation property in the tire, leading to the deterioration of rolling resistance.

The end rubber can be measured for tanδ (25° C.) by the method described in Example of this specification. Then, tanδ (25° C.) of the end rubber or of a coating rubber to be described later may be subjected to adjustment as appropriate by changing, for example, the content and the nitrogen adsorption specific surface area (N₂SA) of a filler such as a carbon black and the like.

<ΔE′>

Then, the aforementioned end rubber may preferably have ΔE′ of 10 MPa or larger, preferably of 25 MPa or larger, and of 30 MPa or smaller, ΔE′ representing a difference between the storage modulus (MPa) at 0.1% strain and the storage modulus (MPa) at 2% strain at 25° C.

The end rubber with ΔE′ falling below 10 MPa leads to insufficient durability of the tire. On the other hand, the end rubber with ΔE′ exceeding 30 MPa leads to insufficient low heat generation property, which deteriorates rolling resistance of the tire. The end rubber can be measured for ΔE′ by the method described in Example of the specification.

Then, ΔE′ of the end rubber may be subjected to adjustment as appropriate by changing, for example, the content of the dispersant (including a hydrazide compound) and the production method.

<Rubber Component>

The end rubber may contain any rubber component which is not particularly limited, and may preferably contain a diene rubber. Examples of the diene rubber, which is not particularly limited, may include, for example: a natural rubber (NR); an isoprene rubber (IR); a butadiene rubber (BR); a styrene butadiene rubber (SBR); a chloroprene rubber (CR); an acrylonitrile butadiene rubber (NBR); and the like. Of those, the end rubber may preferably contain at least one of a natural rubber and a polyisoprene rubber, with natural rubber being more preferred, in order to ensure the durability of the pneumatic tire.

The content of natural rubber in the rubber component of the end rubber may preferably be 50 mass % or more, more preferably be 70 mass % or more, and particularly preferably be 90 mass % or more. With the content of natural rubber in the rubber component being 50 mass % or more, the crack growth resistance in the end rubber can be ensured, which can enhance the durability of the pneumatic tire. Here, the balance in the rubber component is composed of synthetic rubber.

<Carbon Black>

The end rubber may preferably contain a carbon black having a nitrogen adsorption specific surface area (N₂SA) which is preferably 70 m²/g or more, and more preferably 90 m²/g or more. With the carbon black being contained in the end rubber having N₂SA of 70 m²/g or more, the crack growth resistance in the end rubber can be ensured, which can enhance the durability of the pneumatic tire. The upper limit of N₂SA of the carbon black contained in the end rubber is not particularly limited, but may preferably be 270 m²/g or less in consideration of the dispersibility of the carbon black.

Then, in the case where the end rubber contains a diene rubber, the content of the carbon black having N₂SA of 70 m²/g or more in the end rubber may preferably be 50 parts by mass or more, more preferably be 60 parts by mass or more, and preferably be 90 parts by mass or less, more preferably be 80 parts by mass or less, per 100 parts by mass of the diene rubber. When the end rubber contains a carbon black having N₂SA of 70 m²/g or more of 50 parts by mass or more per 100 parts by mass of the diene rubber, the crack growth resistance of the end rubber can be ensured, which can enhance the durability of the pneumatic tire. Meanwhile, the content of the carbon black is defined to be 90 parts by mass or less so as to ensure the low heat generation property of the tire, to thereby reduce the rolling resistance.

<Hydrazide Compound>

The end rubber may preferably contain a hydrazide compound. The end rubber containing a hydrazide compound is capable of improving the dispersibility of the carbon black, so as to enhance the durability of the end rubber, which may even enhance the durability of the pneumatic tire. Here, examples of the hydrazide compound may include:
N′-(1-methylethylidene)salicylic acid hydrazide,
N′-(1-methylpropylidene)salicylic acid hydrazide,
N′-(1,3-dimethylbutylidene)salicylic acid hydrazide,
N′-(2-furylmethylene)salicylic acid hydrazide,
1-hydroxy-N′-(1-methylethylidene)-2-naphthoic acid hydrazide,
1-hydroxy-N′-(1-methylpropylidene)-2-naphthoic acid hydrazide,
1-hydroxy-N′-(1,3-dimethylbutylidene)-2-naphthoic acid hydrazide,
1-hydroxy-N′-(2-furylmethylene)-2-naphthoic acid hydrazide,
3-hydroxy-N′-(1-methylethylidene)-2-naphthoic acid hydrazide,
3-hydroxy-N′-(1-methylpropylidene)-2-naphthoic acid hydrazide,
3-hydroxy-N′-(1,3-dimethylbutylidene)-2-naphthoic acid hydrazide,
3-hydroxy-N′-(2-furylmethylene)-2-naphthoic acid hydrazide, and the like.
   Those compounds each may be used alone or in combination of two or more. Of those, 3-hydroxy-N′-(1,3-dimethylbutylidene)-2-naphthoic acid hydrazide is preferred in view of improving the durability of the pneumatic tire.

The content of a hydrazide compound in the end rubber is not particularly limited, and may preferably 0.1 parts by mass or more, more preferably 0.5 parts by mass or more, and preferably 5 parts by mass or less, more preferably 3 parts by mass or less, per 100 parts by mass of the diene rubber. When the end rubber contains a hydrazide compound in the aforementioned amount, the dispersibility of the carbon black is improved so that the crack growth resistance of the end rubber can be ensured, which can enhance the durability of the pneumatic tire.

<Other Components>

The end rubber may contain other components, in addition to the aforementioned rubber component, a carbon black having N₂SA falling within the aforementioned specific range, and a hydrazide compound. Examples of the other components may include, for example: a vulcanizing agent such as sulfur and the like; a filler such as silica or a carbon black having N₂SA falling out of the aforementioned specific range; zinc oxide; antioxidant; a vulcanization accelerator; organic acid cobalt; or the like.

<Preparation of End Rubber>

The method of preparing the end rubber is not particularly limited, and the end rubber may be prepared by the usual method. In the case of using a natural rubber as a component of the end rubber, a rubber master batch, which is produced by mixing a natural rubber latex with a slurry solution of a carbon black previously dispersed into a liquid, is added with other components as appropriate so as to be obtained as a rubber composition, and the rubber composition may be molded into a sheet-like shape so as to be formed as an end rubber. In other words, the end rubber may preferably be the one that can be obtained using a rubber master batch produced by mixing a natural rubber latex with a slurry solution of a carbon black previously dispersed into a liquid. The end rubber may be prepared through the aforementioned rubber batch, to thereby improve dispersibility of the carbon black, so as to ensure the crack growth resistance of the end rubber, which can enhance the durability of the pneumatic tire.

The natural rubber latex may be a modified natural rubber latex obtained by, for example, adding a polar group-containing monomer to a natural rubber latex so as to graft-polymerize natural rubber molecules in the natural rubber latex with the polar group-containing monomer.

Exemplary methods of producing a rubber master batch as described above may include those illustrated in JP 2006-143881 A and in JP 4533317 B.

(Coating Rubber)

### <Loss Tangent at 25° C.>

In the pneumatic tire of the present invention, a coating rubber covering a cord in a component having the end rubber at the end thereof has tanδ (25° C.) of 0.20 or less, preferably of 0.15 or less, and particularly preferably of 0.10 or less.

When the coating rubber having tanδ (25° C.) larger than 0.20, the excellent low heat generation property cannot be ensured in the pneumatic tire, which deteriorates the rolling resistance. The lower limit of tanδ (25° C.) of the coating rubber is not particularly limited, but may preferably be 0.01 or more, for example, so as to ensure the crack growth resistance of the coating rubber, to thereby enhance the durability of the pneumatic tire.

<Rubber Component>

The rubber component to be contained in the coating rubber is not particularly limited, and those contained in the end rubber can similarly be used, with preferred components being the same as those in the case of the end rubber. The content of a natural rubber in the rubber component in the coating rubber may preferably fall within a range similar to that in the case of the end rubber.

<Carbon Black>

The coating rubber may preferably contain a carbon black having a nitrogen adsorption specific surface area (N₂SA) which is preferably 90 m²/g or less, and more preferably 80 m²/g or less. Containing, in the coating rubber, a carbon black having N₂SA of 90 m²/g or less, the low heat generation property of the pneumatic tire can be ensured. The lower limit of N₂SA of the carbon black contained in the coating rubber is not particularly limited, but may preferably be 20 m²/g or more in consideration of the crack growth resistance of the coating rubber.

Then, in the case where the coating rubber contains a diene rubber, the content of the carbon black having N₂SA of 90 m²/g or less in the coating rubber may preferably 20 parts by mass or more, more preferably 25 parts by mass or more, and preferably 60 parts by mass or less, more preferably 40 parts by mass or less, per 100 parts by mass of the diene rubber. When the end rubber contains the carbon black having N₂SA of 90 m²/g or less by 20 parts by mass or more per 100 parts by mass of the diene rubber, the crack growth resistance of the coating rubber can be ensured, which can enhance the durability of the pneumatic tire. Meanwhile, the content of the carbon black is defined to be 60 parts by mass or less so as to ensure the low heat generation property of the tire, to thereby reduce the rolling resistance.

<Other Components>

The coating rubber may contain other components, in addition to the aforementioned rubber component and carbon black having N₂SA falling within the aforementioned specific range. Examples of the other components may include, for example: a vulcanizing agent such as sulfur and the like; a filler such as silica or a carbon black having N₂SA falling out of the aforementioned specific range; zinc oxide; antioxidant; a vulcanization accelerator; organic acid cobalt; a hydrazide compound; or the like.

<Preparation of Coating Rubber and its Application to Pneumatic Tire>

The method of preparing the coating rubber is not particularly limited, and the coating rubber may be prepared by the usual method. Then, the coating rubber may be embedded with a cord such as a steel cord and the like so that the coating rubber can be applied to a carcass cord ply, a belt cord layer, and bead portion reinforcing cord layer of the pneumatic tire of the present invention. The pneumatic tire of the present invention, in which the low heat generation property and the durability are both satisfied at high level, can be particularly suitably used as a pneumatic tire for heavy load for use in, for example, tracks, buses, aircrafts and so on, in particular.

### EXAMPLES

Next, the pneumatic tire according to the present invention was prototyped and subjected to performance evaluation, the results of which are described in below. Examples 1 to 5 and Comparative Examples 1 to 3 are pneumatic tires for heavy load each in a tire size of 11R22.5, and each include a sheet-like end rubber on both ends of one belt cord layer as illustrated in FIG. 1. A steel cord was employed as the cord in all the Examples. The following methods were used to measure or calculate tanδ (25° C.), ΔE′, the rolling resistance (low heat generation property), and the crack growth resistance (durability) of the tires.

<tanδ (25° C.)>

A rubber composition was vulcanized to obtain a vulcanized rubber, which was subjected to the measurement of loss tangent (tanδ) at the frequency of 52 Hz, the initial load of 160 g, the measurement temperature of 25° C. (room temperature), and at 2% strain, using a spectrometer available from TOY( )SEIKI Co., Ltd. <ΔE′>

A rubber composition was vulcanized to obtain a vulcanized rubber, which was subjected to the measurement of storage modulus (E′) at the frequency of 52 Hz, the initial load of 160 g, the measurement temperature of 25° C. (room temperature), and at the respective strains of 0.1% and of 2%, using a spectrometer available from TOYO SEIKI Co., Ltd, so as to calculate the difference (ΔE′) between the storage modulus (E′) at 0.1% strain and the storage modulus (E′) at 2% strain.

### <Rolling Resistance (Low Heat Generation Property)>

Molded and vulcanized sample tires were measured for rolling resistance on a drum driving at 80 km/h under a normal load and internal pressure, the results of which are shown in Table 3 as index values with the value obtained for Comparative Example 1 being 100. A smaller index value shows smaller rolling resistance and more excellent low heat generation property.

### <Crack Growth Resistance (Durability)>

Molded and vulcanized sample tires were subjected to drum test for 2 days in the atmosphere of 40° C. with a normal internal pressure and under a normal load, as being applied with a constant side force (15 kN), on the condition of 60 km/h. A belt cord layer having a belt end rubber at both ends thereof was taken out after the drum test was over, so as to measure the crack length on the ends of the belt cord layer.

The inverses of each crack length are shown in Table 3 as index values with the value obtained for Comparative Example 1 being 100. A larger index value shows more excellent crack growth resistance and more excellent durability.

The following rubber compositions were adopted as the coating rubber and the end rubber of the belt layer (hereinafter, each referred to as ‘belt coating rubber’ and ‘belt end rubber’, respectively).

(Belt Coating Rubber)

The respective components of Compositions A to D shown in Table 1 were kneaded by the usual method, which were then warmed and extruded, so as to be obtained as rubber compositions. The rubber compositions thus obtained were each applied, as the belt coating rubber, to the belt cord layer of a pneumatic tire for heavy load, as shown in Table 3.

TABLE 1

Belt Coating Rubber Composition
(Parts by Mass)

| | Com- | Com- | Com- | Com- |
|---|---|---|---|---|
| | posi- | posi- | posi- | posi- |
| | tion A | tion B | tion C | tion D |
| Natural Rubber | 100 | 100 | 100 | 100 |
| Carbon Black A *1 | — | — | 60 | — |
| Carbon Black B *2 | 60 | 30 | — | 15 |
| Zinc Oxide | 8 | 8 | 8 | 8 |
| Antioxidant *4 | 2 | 2 | 2 | 2 |
| Vulcanization | 1 | 1 | 1 | 1 |
| Accelerator *5 | | | | |
| Sulfur | 5 | 5 | 5 | 5 |
| Organic Acid | 0.5 | 0.5 | 0.5 | 0.5 |
| Cobalt *6 | | | | |
| tanδ | 0.20 | 0.15 | 0.25 | 0.10 |

(Belt End Rubber)

<Compositions a, b>

According to the method described in Example 1 of the specification of JP 4533317 B, a natural rubber latex was mixed with a slurry solution of a carbon black C previously dispersed into a liquid, to thereby produce rubber master batches each including a natural rubber and the carbon black C at the ratio of 10:8 and 10:6 (both being the mass ratio), respectively. The rubber master batches were kneaded with the remaining components shown in Table 2, other than the natural rubber and the carbon black C, by the usual method, and then warmed and extruded, to thereby obtain rubber compositions. The rubber compositions thus obtained were each applied as the belt end rubber to a pneumatic tire for heavy load, as shown in Table 3.

<Compositions c to e>

The compositions c to e shown in Table 2 were each kneaded, and warmed and extruded by the usual method, to thereby obtain rubber compositions. The rubber compositions were each applied as the belt end rubber to the pneumatic tire for heavy load as shown in Table 3.

TABLE 2

| | Belt End Rubber Composition | | | | |
|---|---|---|---|---|---|
| | (Parts by Mass) | | | | |
| | Com- | Com- | Com- | Com- | Com- |
| | posi- | posi- | posi- | posi- | posi- |
| | tion a | tion b | tion c | tion d | tion e |
| Natural Rubber | 100 | 100 | 100 | 100 | 100 |
| Carbon Black A *1 | — | — | — | — | 60 |
| Carbon Black B *2 | — | — | — | — | — |
| Carbon Black C *3 | 80 | 60 | 60 | 60 | — |
| Zinc Oxide | 8 | 8 | 8 | 8 | 8 |
| Antioxidant *4 | 2 | 2 | 2 | 2 | 2 |
| Dispersant *7 | — | — | 1 | — | — |
| Vulcanization | 1 | 1 | 1 | 1 | 1 |
| Accelerator *5 | | | | | |
| Sulfur | 5 | 5 | 5 | 5 | 5 |
| Organic Acid | 0.5 | 0.5 | 0.5 | 0.5 | 0.5 |
| Cobalt *6 | | | | | |
| Rubber Master | used | used | unused | unused | unused |
| Batch | | | | | |
| tan δ | 0.35 | 0.3 | 0.3 | 0.35 | 0.2 |
| ΔE′ | 30 | 25 | 30 | 40 | 30 |

The details of the components shown in Tables 1, 2 are as follows.
*1 Produced by ASAHI CARBON CO., LTD., HAF class (N₂SA 82 m²/g)
*2 Produced by ASAHI CARBON CO., LTD., FEF class (N₂SA 42 m²/g)
*3 Produced by ASAHI CARBON CO., LTD., ISAF class (N₂SA 115 m²/g)
*4 N-(1,3-dimethylbutyl)-N′-phenyl-p-phenylenediamine
*5 N,N′-dicyclohexyl-2-benzothiazylsulfenamide
*6 Produced by OMG, Inc., MANOBOND C with the cobalt content of 22.5%
*7 3-hydroxy-N′-(1,3-dimethylbutylidene)-2-naphthoic acid hydrazide (synthesized by the method of Synthetic Example 2 illustrated in JP H10-330549 A)

TABLE 3

| | | | | | | | Comparative | Comparative | Comparative |
|---|---|---|---|---|---|---|---|---|---|
| | | Example 1 | Exmaple 2 | Example 3 | Example 4 | Example 5 | Example 1 | Example 2 | Example 3 |
| Belt Coating | Composition | A | B | D | A | A | C | A | A |
| Rubber | tanδ | 0.20 | 0.15 | 0.10 | 0.20 | 0.20 | 0.25 | 0.20 | 0.20 |
| Belt End | Composition | b | b | b | a | c | b | d | e |
| Rubber | tanδ | 0.3 | 0.3 | 0.3 | 0.35 | 0.3 | 0.3 | 0.35 | 0.2 |
| | ΔE′ | 25 | 25 | 25 | 30 | 30 | 25 | 40 | 30 |

| | | | | | | | | |
|---|---|---|---|---|---|---|---|---|
| Rolling Resistance | 95 | 90 | 85 | 96 | 96 | 100 | 103 | 95 |
| (Low Heat Generation | | | | | | | | |
| Property) | | | | | | | | |
| Durability | 100 | 100 | 100 | 110 | 108 | 100 | 98 | 80 |
| (Crack Growth [symbol] | | | | | | | | |

[symbol]

indicates data missing or illegible when filed

It can be appreciated from Table 3 that a pneumatic tire for heavy load that uses a belt coating rubber having tanδ of 0.20 or less and a belt end rubber having tanδ larger than 0.20 and 0.35 or smaller while having ΔE′ of 10 MPa or more and 30 MPa or less for a belt cord layer has excellent low heat generation property (rolling resistance) and durability (crack growth resistance).

### INDUSTRIAL APPLICABILITY

According to the present invention, there can be provided a pneumatic tire in which low heat generation property and durability are both satisfied at a high level.

### REFERENCE SIGNS LIST

1 bead portion
2 sidewall portion
3 tread portion
4 carcass
4-1 carcass cord ply
4t turn-up portion
5 bead core
6 belt
6-1 belt cord layer
6-2 belt cord layer
7 bead portion reinforcing cord layer
8 stiffener rubber
10-1 end rubber
10-2 end rubber
10-3 end rubber
11 pneumatic tire
R rim

1. A pneumatic tire, comprising: a carcass formed of a carcass cord ply which toroidally extends across a pair of bead portions each having a bead core embedded therein, a pair of sidewall portions, and a tread portion; and a belt formed of a belt cord layer disposed on the tire-radial-direction outside of a crown portion of the carcass, wherein:
at least one component member selected from the group consisting of the carcass cord ply and the belt cord layer includes an end rubber wrapping the end part of the at least one component member;
the end rubber has a loss tangent (tanδ) at 2% strain at 25° C. of larger than 0.20 and 0.35 or smaller, and a difference ΔE′ between the storage modulus (MPa) at 0.1% strain and the storage modulus at 2% strain at 25° C. of 10 MPa or more and 30 MPa or less; and
a coating rubber covering a cord in the at least one component member including the end rubber has a loss tangent (tanδ) at 2% strain at 25° C. of 0.20 or less.

2. The pneumatic tire according to claim 1, wherein the at least one component member including the end rubber is a belt cord layer.

3. A pneumatic tire, comprising: a carcass formed of a carcass cord ply which toroidally extends across a pair of bead portions each having a bead core embedded therein, a pair of sidewall portions, and a tread portion; a belt formed of a belt cord layer disposed on the tire-radial-direction outside of a crown portion of the carcass; and a bead portion reinforcing cord layer disposed along a turn-up portion of the carcass, wherein:
the bead portion reinforcing cord layer includes an end rubber wrapping the end part thereof;
the end rubber has a loss tangent (tanδ) at 2% strain at 25° C. of larger than 0.20 and 0.35 or smaller a difference ΔE′ between the storage modulus (MPa) at 0.1% strain and the storage modulus at 2% strain at 25° C. of 10 MPa or more and 30 MPa or less; and a coating rubber covering a cord in the bead portion reinforcing cord layer has a loss tangent (tanδ) at 2% strain at 25° C. of 0.20 or less.

4. The pneumatic tire according to claim 1, wherein the coating rubber contains: a diene rubber; and a carbon black having a nitrogen adsorption specific surface area (N₂SA) of 90 m²/g or less in an amount of 20 to 60 parts by mass per 100 parts by mass of the diene rubber.

5. The pneumatic tire according to claim 3, wherein the coating rubber contains: a diene rubber; and a carbon black having a nitrogen adsorption specific surface area (N₂SA) of 90 m²/g or less in an amount of 20 to 60 parts by mass per 100 parts by mass of the diene rubber.

6. The pneumatic tire according to claim 1, wherein the end rubber contains: a diene rubber; and a carbon black having a nitrogen adsorption specific surface area (N₂SA) of 70 m²/g or more in an amount of 50 to 90 parts by mass per 100 parts by mass of the diene rubber.

7. The pneumatic tire according to claim 3, wherein the end rubber contains: a diene rubber; and a carbon black having a nitrogen adsorption specific surface area (N₂SA) of 70 m²/g or more in an amount of 50 to 90 parts by mass per 100 parts by mass of the diene rubber.

8. The pneumatic tire according to claim 1, wherein the end rubber is obtained by using a rubber master batch produced by mixing a natural rubber latex with a slurry solution of a carbon black previously dispersed into a liquid.

9. The pneumatic tire according to claim 3, wherein the end rubber is obtained by using a rubber master batch produced by mixing a natural rubber latex with a slurry solution of a carbon black previously dispersed into a liquid.

10. The pneumatic tire according to claim 1 wherein the end rubber contains a hydrazide compound.

11. The pneumatic tire according to claim 3 wherein the end rubber contains a hydrazide compound.

12. The pneumatic tire according to claim 1, wherein the end rubber and the coating rubber each contain at least one of a natural rubber and a polyisoprene rubber.

13. The pneumatic tire according to claim 3, wherein the end rubber and the coating rubber each contain at least one of a natural rubber and a polyisoprene rubber.

14. The pneumatic tire according to claim 1, wherein each of the end rubber and the coating rubber contains a rubber component comprising 50 mass % or more of a natural rubber.

15. The pneumatic tire according to claim 3, wherein each of the end rubber and the coating rubber contains a rubber component comprising 50 mass % or more of a natural rubber.
